(19) United States
(12) Patent Application Publication
(10) Pub. No.: US 2017/0240119 A1
(43) Pub. Date: Aug. 24, 2017

(54) Case Seat Assembly

(71) Applicant: Dawn Tezino, Kingwood, TX (US)

(72) Inventor: Dawn Tezino, Kingwood, TX (US)

(21) Appl. No.: 15/049,078

(22) Filed: Feb. 20, 2016

(51) Int. Cl. B60R 11/00; F16B 2/10; B60R 7/08; F16M 13/02; B60R 11/02

(52) U.S. Cl. CPC B60R 11/00; F16M 13/022; B60R 11/0241; B60R 7/082; F16B 2/10; B60R 2011/0085; B60R 2011/007; B60R 2011/0077; B60R 2011/0059

(57) ABSTRACT

The present invention provides a case seat assembly that is removably attached to a small case containing small items such as eyeglass case, cellphone case, or another small case. The assembly further comprises a base, clamp, and a kickstand. The base is coupled to the outer surface of the small case. Mounted to one side of the clamp is an attaching element that is configured to be rotatably and removably coupled to the base. While in use the clamp is detached from the small case and configured to attach a sun visor, belt, bag, purse or other suitable item. The clamp further comprises a hingedly connected kickstand that allows the case to be suspended in an upright position and the clamp can be detached from the base.

This application claims the benefit of provisional application 62/119,095

### BACKGROUND OF THE INVENTION

This invention relates to an assembly for a case seat which is configured to attach to the outer surface of a small case containing items such as eyeglasses, a cellphone, or other similar small items.

When driving a car, it is sometimes necessary to wear sunglasses to protect eyes from bright sunlight exposure. When sunglasses are not in use while driving, they need to be in a safe and accessible place. A conventional eyeglass case or small case cannot be attached to a single place. Additionally, having an easily accessible stand for a cell phone is also desirably. The present invention provides an improved case seat that easily transitions between a fastener to secure a case in place into a stand that allows the case to be suspended in an upright position.

### SUMMARY OF THE INVENTION

One object of this invention is to provide for a case seat assembly that attaches to the outer surface of a small storage container containing eyeglasses, a cellphone or other small items. The case seat has a base with a coupling portion that has a face which is attached abutting the surface of the storage container. The opposite side of the coupling portion has a mating attaching element which removably connects to a female attaching element encompassed within a housing which is rotatably mounted to one side of a clamp fastener. In use the clamp has a fastener that detaches from the coupling portion and attaches to a belt, sun visor, purse, bag or other type of item. The backside of the clamp fastener has a recessed portion that receives a kickstand for holding the storage container in an upright position.

### DESCRIPTION OF DRAWINGS

FIG. 1 is an exploded view of one embodiment of the case seat assembly.

FIG. 2 is a front view of one embodiment the case seat assembly.

FIG. 3 is a side view of one embodiment case seat assembly with glass case attached and kickstand

FIG. 4 is side view of one embodiment case assembly with glass case attached and kickstand closed.

FIG. 5 is an exploded view of the preferred embodiment of the case seat assembly

FIG. 6 is a perspective view the preferred embodiment of the case seat assembly.

FIG. 7A is a back view of the preferred embodiment of the case seat assembly.

FIG. 7B is a front view of the preferred embodiment of the case seat assembly.

FIG. 7C is a side perspective view of the preferred embodiment of the case seat assembly.

FIG. 7D is a frontal perspective view of the preferred embodiment of the case seat assembly.

FIG. 8 is an exploded view of the preferred embodiment of the case seat assembly

### DETAILED DESCRIPTION OF THE INVENTION

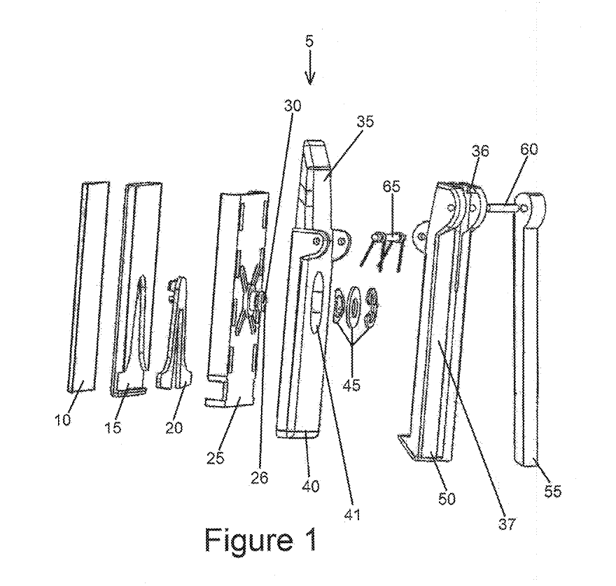

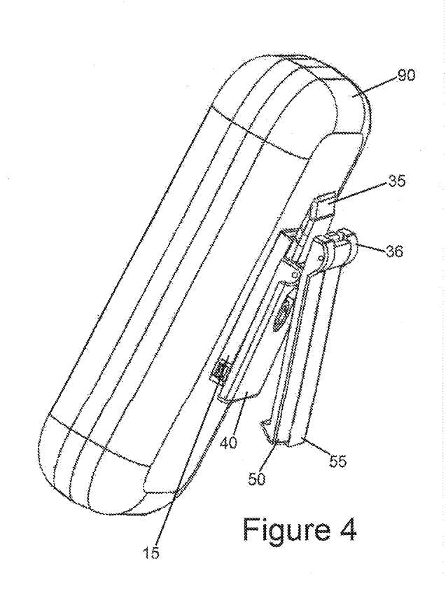

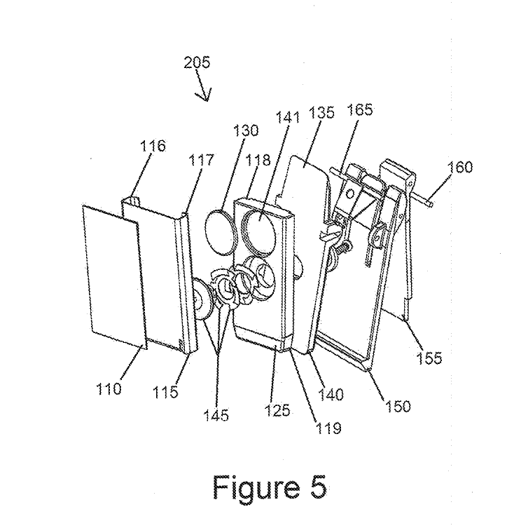

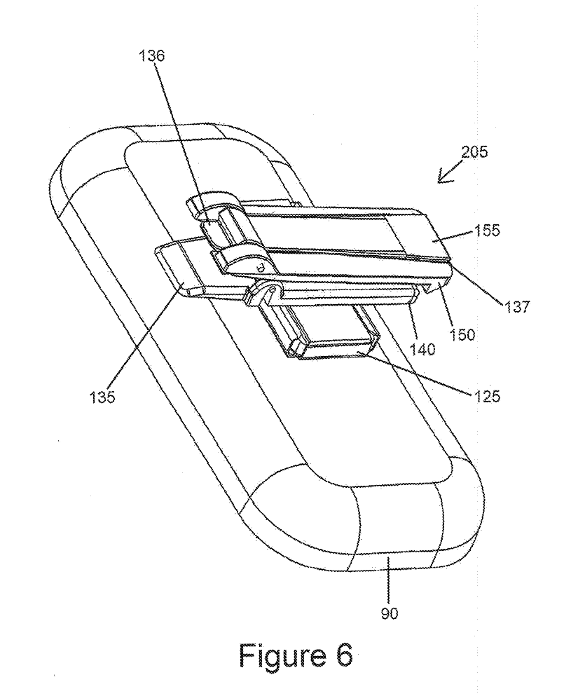

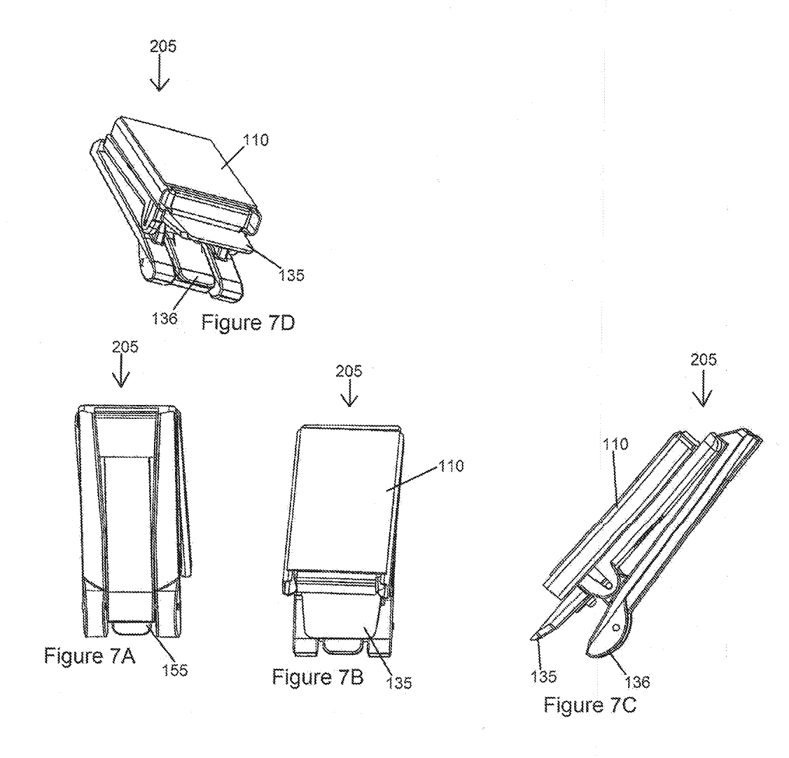

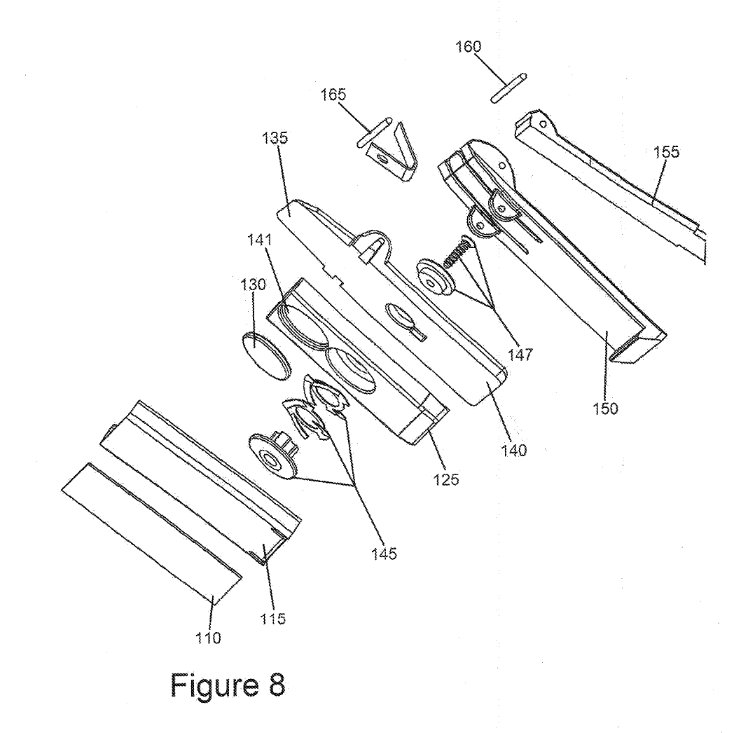

Referring to FIGS. 1 and 5, there are shown exploded embodiments of the case seat assembly (5) according to the present invention. As shown in one embodiment in FIG. 4, the present invention comprises a base (15) with a back side that is attached to the surface of the case (90), a rotatable housing (25), kick stand (55) and a clamp fastener defined by upper portion (35, 36) and lower portion(40, 50). As shown in the preferred embodiment in FIG. 6, the present invention comprises a base (115) with a back side that is attached to the surface of the case (90) a rotatable housing (125), kick stand (155) and a clamp fastener defined by upper portion (135, 136) and lower portion(140, 150). In the preferred embodiment the rotatble element (145) is disposed within the housing (125).

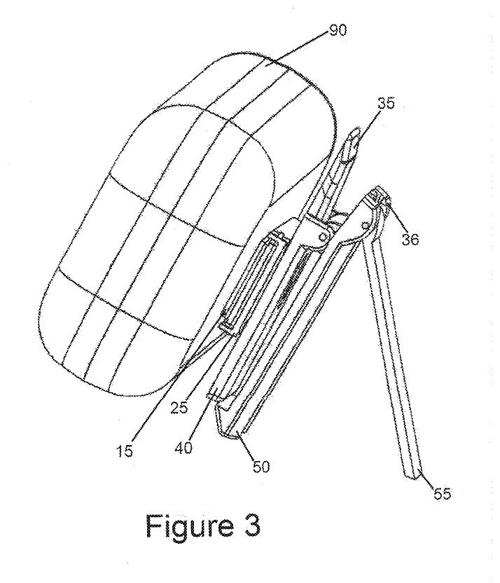

In the embodiment, depicted in FIG. 1 is an exploded view of the case seat assembly (5) of the present invention. Base (10) can have a circular, oval, elliptical or polygonal shape. In some embodiments base (10) can be permanently attached to the outer surface of the case (90) as shown in FIGS. 3 and 4 using some type of adhesive or in alternative embodiments base (10) can be removable mounted to the outer surface of case (90) using fasteners such as magnets and Velcro.

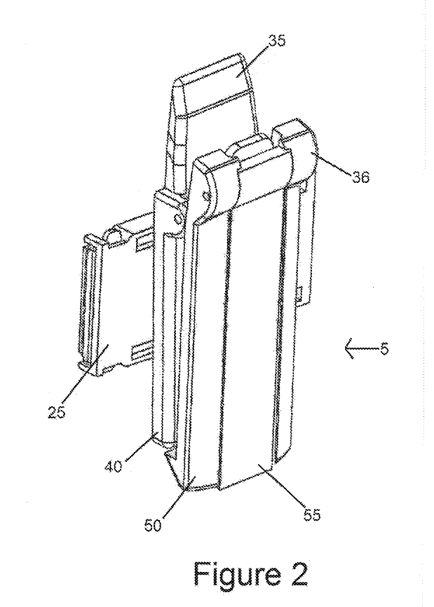

As shown is FIG. 1, coupling portion (15) has one side that is permanently affixed to the back side of base (10) and the opposite side forms a male attaching element. Female attaching element (20) interconnects with the male attaching element incorporated within coupling portion (15) and can be removably attached therefrom. Housing (25) has an underside that forms a compartment for receiving female attaching element (20) and coupling portion (15) therein. Housing (25) forms a cover with an exposed face that is rotatably mounted with one side of the clamp fastener. As shown in FIG. 1, housing (25) is configured with a rotatable element (26) which interconnects through a centrally located aperture (41) within clamp portion (40) to mating rotating elements (45). As shown in FIG. 2, housing (25) rotating connection allows clamp fastener to rotate 360 degrees in relation to housing (25). In alternative embodiments, rotatable element (26) can be configured to rotate in step increments of 30 degrees.

Clamp fastener is formed with an upper portion (35, 36) and lower portion (50, 40). As shown in FIG. 2, the upper portion comprises opposing levers (35, 36) that is hingedly connected through rod element (65) in a spaced apart relationship. The bottom portion of the clamp fastener comprises opposing tongs (40, 50) that are adjacent and abuts each other as they extend linearly downward in a parallel arrangement. The backside of tong (40) is rotatably mounted to housing (25) and the backside of tong (50) has a recessed portion (37) incorporated therein for receiving kickstand (55). At the upper end of kickstand (55) is hinge connection (60) which allows kickstand (55) to swing backward and forward within recessed portion (37).

Kickstand (55) is a device that allows the case (90) to be kept upright without leaning against another object or the aid of a person. In use, kickstand (55) is a bar that flips down from recessed portion (37) and makes contact with a flat surface. As shown in FIG. 3, kickstand (55) extends outward forming a small angle less than 90 degrees to hold the case in an upright position.

Depicted in FIG. 5 is an exploded view of the preferred embodiment of case seat assembly (205) of the present invention. Base (110) can have a circular, oval, elliptical or polygonal shape. In some embodiments base (110) can be permanently attached to the outer surface of the case (90) using some type of adhesive or in alternative embodiments base (110) can be removable mounted to the outer surface of case (90) using fasteners such as magnets and Velcro.

As shown is FIG. 6, coupling portion (115) has one side that is permanently affixed to the back side of base (110) and the opposite side forms a male attaching element. Female attaching element (20) interconnects with the male attaching element incorporated within coupling portion (115) and can be removably attached therefrom. Housing (125) has an underside that forms a compartment for receiving female attaching element (120) and coupling portion (115) therein. Housing (125) forms a cover with an exposed face that is rotatably mounted with one side of the clamp fastener. Opposing edges (118, 119) of housing (125) engages with channels (116, 117) of coupling member (115). Housing (125) can slide in and out of coupling member (115).

As shown in FIG. 5, housing (125) is configured interconnects through a centrally located aperture (141) within clamp portion (140) to mating rotating elements (145). Rotating elements (145) comprises a plug (126) which is flushed with at least one washer to absorb friction. In the depicted embodiment there are two finger spring washers. Mating plug element (127) extends through the aperture in the front side tong of clamp fastener to securely engage with plug (126) wherein rotating element (145) is operationally coupled thereto. As shown in FIG. 2, housing (125) rotating connection allows clamp fastener to rotate 360 degrees in relation to housing (125). In alternative embodiments, rotatable element (126) can be configured to rotate in step increments of 30 degrees. In the preferred embodiment, rotating element (145) can swivel left and right but not 180 degrees. In the preferred embodiment plug (126) is a swivel plug which allows the housing and the coupling member to swivel left and right. Magnet (130) can be installed within aperture (135) directly above aperture (141). Magnet (130) can be neodinium with an adhesive pad. Magnet (130) can provide a magnetic field to secure the washers and plug (126) within aperture 141.

Clamp fastener is formed with an upper portion (135, 136) and lower portion (150, 140). As shown in FIG. 5, the upper portion comprises opposing levers (135, 136) that is hingedly connected through rod element (165) in a spaced apart relationship. The bottom portion of the clamp fastener comprises opposing tongs (140, 150) that are adjacent and abuts each other as they extend linearly downward in a parallel arrangement. The backside of tong (140) is rotatably mounted to housing (125) and the backside of tong (150) has a recessed portion (137) incorporated therein for receiving kickstand (155). At the upper end of kickstand (155) is hinge connection (160) which allows kickstand (155) to swing backward and forward within recessed portion (137).

Kickstand (155) is a device that allows the case (90) to be kept upright without leaning against another object or the aid of a person. In use, kickstand (155) is a bar that flips down from recessed portion (137) and makes contact with a flat surface. As shown in FIG. 5, kickstand (155) flips outward forming a small angle less than 90 degrees to hold the case in an upright position. Kickstand (155) can be used in landscape or portrait mode. Additionally, in other embodiments, the lower end of kickstand (115) can be removed and made of soft plastic, rubber or another suitable gripping material.

In use as shown in FIGS. 3, 4 and 6, clamp fastener is configured to hold or secure case (90) tightly to a belt, purse or visor. As depicted initially, base (10) and (110) are attached to case (90). Referring to FIG. 6, then, inward pressure is applied to levers (135, 136) thereby forcing tongs (140, 150) outward to secure an item therein when opposing levers (135, 136) are released. Referring to FIGS. 3 and 4, in use, inward pressure is applied to levers (35, 36) thereby forcing tongs (40, 50) outward to secure an item therein when opposing levers (135, 136) are released. To stand the case (90), kickstand (55, 155) is extended outward to allow case (90) to stand upright on a flat surface as illustrated in FIGS. 3, 4 and 5.

What is claimed is:

1. A mount utilized in combination with a small case, the mount comprising
a base with an adhesive for attachment to an outer surface of the small case;
a coupling member attached to the base;
a housing operationally coupled to the coupling member;
a clamp fastener having a front side tong and a back side tong;
a front top portion of the front side tong hingedly connected to a back top portion of the back side tong and extending linearly downward therefrom; and
a rotational mechanism operationally coupling the housing to the front side tong through an aperture extending through a median section of the front side tong and the housing.

2. The mount of claim 1 wherein the rotational mechanism swivels back and forth.

3. The mount of claim 1 wherein the rotational mechanism rotates 360 degrees.

4. The mount of claim 1 wherein the rotational mechanism rotates in increments of 30 degrees.

5. The mount of claim 1 wherein a magnet is installed within the housing directly above the aperture supporting the rotational mechanism.

6. The mount of claim 5 wherein the magnet is neodinium.

7. The mount of claim 1 wherein the base is removably attached to the small case.

8. The mount of claim 1 wherein the small case is a cell phone case.

9. The mount of claim 1 wherein the housing is removable connected to the coupling member.

10. The mount of claim 1 further comprising:
a kickstand disposed within a recessed portion extending linearly downward disposed within an outer surface of the back side tong;
the recessed portion configured to receive the kickstand therein; and
the kickstand having an upper portion hingedly connected therein wherein the kickstand can extend forward and backwards therefrom.

11. The mount of claim 1 wherein the housing has opposing edges that interconnect with opposing channels of the coupling member.

12. The mount of claim 10 wherein the kickstand has a lower portion that is removable.

13. The mount of claim 12 wherein the lower portion is made of a gripping material.
